(19) United States
(12) Patent Application Publication
(10) Pub. No.: US 2022/0325733 A1
(43) Pub. Date: Oct. 13, 2022

(54) A RELEASABLE FASTENING DEVICE

(71) Applicant: Bag'in AS, Drøbak (NO)

(72) Inventors: Kåre Normann SEKKESÆTER, Drøbak (NO); Inger Helene ROSSING, Oslo (NO); Erik Pavels PETTERSEN, PORSGRUNN (NO)

(21) Appl. No.: 17/621,662

(22) PCT Filed: Jun. 26, 2020
(86) PCT No.: PCT/NO2020/050183

§ 371 Date: Dec. 21, 2021

(30) Foreign Application Priority Data
Jun. 27, 2019 (NO) 20190803

(51) Int. Cl. F16B 5/02; F16B 37/04; F16B 33/00

(52) U.S. Cl. CPC F16B 5/0266; F16B 37/046; F16B 33/002; E04H 15/62

(57) ABSTRACT

A releasable fastening device for boards, comprising an anchor configured for insertion between two adjacent boards and abutment with an underside of the boards. The releasable fastening device further comprises a rod in threaded connection with the anchor and a rotation element connected to the rod. The rotation element is configured for positioning on a topside of the boards and configured for being rotated by a user. The rotation element is configured for rotating the rod to thereby screw the anchor towards the rotation element.

The invention relates to a releasable fastening device, and more specifically to a releasable fastening device for boards.

### BACKGROUND

Terraces, and different raised floors and other structures, are provided by arranging boards side by side. The boards may be wooden, or may be made of composite or similar materials. The boards are commonly arranged spaced apart in between 2-10 mm such that water is drained from the floor, and the boards are allowed to swell and move somewhat without creating tension.

On such terraces and structures there may sometimes be a need for securing various equipment or even other structures. Such equipment and structures may be tents, covers for garden furniture, terrace lamps, hammocks, umbrellas, etc. These may be commonly secured by means of ropes, straps, wires, etc. When it is not practical or possible to anchor or connect ropes and straps directly to the terrace or structure, a fastening device may be utilized for easy and secure fastening. Such fastening devices may be commonly known bolts, hooks and nails.

However, oftentimes it is undesirable to permanently anchor something to the terrace or structure, and bolts, hooks and nails, however small, leave a mark when removed, thus permanently damaging the appearance of the structure. This is a major problem with known fastening devices. It is therefore not desirable to move a bolt or nail around to see where it serves the best function, which may result in a positioning of the fastening device that is not optimal.

It may also be cumbersome and difficult for a person not skilled in the art to sufficiently anchor a commonly known fastening device intended to secure a heavy load to a structure where boards are arranged side by side. Known fastening devices may also protrude up from the floor or similar structure, making the fastening devices both visually unattractive and in the way when not in use.

Document CN 106468297 A describes a fastener having a handle so as to be fastened to a a second object. The fastener is provided with a head portion for engaging a fastening portion of the second object.

Document US 2018156256 A1 describes a fastening part that has a pin body that is inserted in a through hole formed in a member of an object to be installed. The pin body has elastic sections and locking parts that form pairs.

There is therefore a need for an improved releasable fastening device to reduce or eliminate the above mentioned disadvantages of known techniques. It is an objective of the present invention to achieve this and to provide further advantages over the state of the art.

### SUMMARY

In an embodiment, there is provided a releasable fastening device for boards, comprising an anchor configured for insertion between two adjacent boards and abutment with an underside of the boards, a rod in threaded connection with the anchor, a rotation element connected to the rod, the rotation element configured for positioning on a topside of the boards and configured for being rotated by a user; the rotation element configured for rotating the rod to thereby screw the anchor towards the rotation element.

According to another embodiment of the invention, the fastening device further comprises a base positioned between the anchor and the rotation element, thus preventing direct contact between the rotation element and the boards.

According to another embodiment of the invention, the base further comprises a recess for accommodating the rotation element.

According to another embodiment of the invention, the base comprises openings for visual inspection and water drainage.

According to another embodiment of the invention, the fastening device further comprises a spring positioned between the base and the rotation element, the spring is configured for compression as the anchor is positioned on the underside of the boards and biases the anchor towards the underside of the boards.

According to another embodiment of the invention, the spring is helical and the rod extends through the spring.

According to another embodiment of the invention, the anchor comprises at least one friction element for increasing the friction with the underside of the boards.

According to another embodiment of the invention, the at least one friction element is a point.

According to another embodiment of the invention, the anchor comprises two friction elements.

According to another embodiment of the invention, the anchor is elongate.

According to another embodiment of the invention, the anchor is symmetrical about a longitudinal axis.

According to another embodiment of the invention, the rotation element comprises connection means for connecting external devices to the fastening device.

According to another embodiment of the invention, the connection means is an opening through the rotation element.

According to another embodiment of the invention, the rotation element comprises openings for visual inspection and water drainage.

According to another embodiment of the invention, the rod comprises a stopper for preventing the anchor from being disconnected from the rod.

According to another embodiment of the invention, the rod is fixed to the rotation element.

According to another embodiment of the invention, the rod comprises a fixed nut for interlocking with a corresponding opening in the rotation element and is thus configured for preventing rotation of the nut and rod relative to the rotation element.

### BRIEF DESCRIPTION OF THE DRAWINGS

The above and other characteristics will become clear from the following description of embodiments, given as non-restrictive examples, with reference to the attached schematic figures.

FIG. 1 is a perspective view from above of an embodiment of a releasable fastening device.

FIG. 2 is a perspective view from below of a releasable fastening device.

FIG. 3 is a side view of a releasable fastening device and two boards.

FIG. 4 is a section view through a releasable fastening device when not fastened to boards.

FIG. 5 is a section view through a releasable fastening device and boards when fastened to boards.

FIG. 6 is a perspective view of a second embodiment of a releasable fastening device comprising a solar panel and a light source.

### DETAILED DESCRIPTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the figures and that are associated with a normal use of the invention. The terms are used for the reader's convenience only and shall not be limiting.

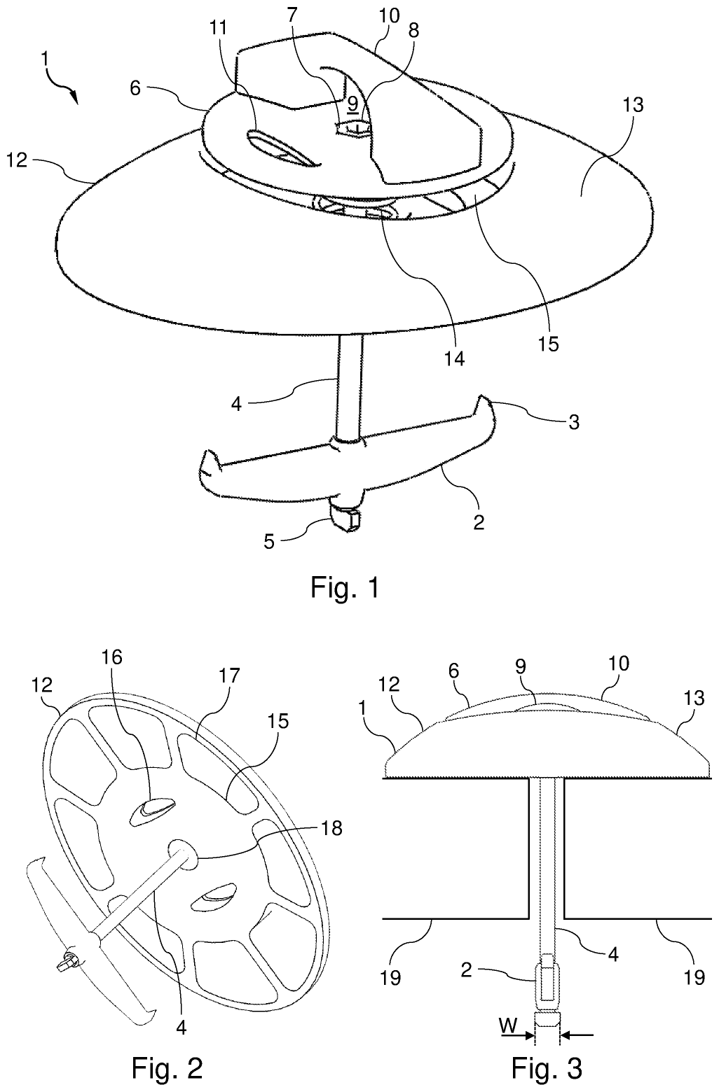

Referring initially to FIG. 1, an embodiment of a releasable fastening device 1 is illustrated. The fastening device 1 comprises an anchor 2. The anchor 2 is configured for insertion between two adjacent boards and abutment with an underside of the boards (described more in detail with reference to FIG. 5). The boards may e.g. be decking boards of a terrace, and are not illustrated in FIG. 1, see FIGS. 3 and 5.

The anchor 2 comprises an elongate body that preferably has a height greater than the width, and a length greater than the height. The anchor 2 is preferably made of a hard and rigid material, such as a metal. The anchor 2 may be relatively stiff at least in a vertical direction, such that it can abut the underside of the boards sufficiently without deforming.

The anchor 2 may comprise friction elements 3 for increasing the friction with the underside of a board. The friction elements 3 are in the illustrated embodiment points positioned at the distal ends of the elongated anchor 2. Points may penetrate the boards somewhat and thus create a solid fixation. Alternatively, the friction elements 3 may simply be a rough surface on the anchor 2, a soft area such as a rubber stud, or any other element that may increase friction between a rigid anchor 2 and an underside of a board.

The anchor 2 is connected to a rod 4. The connection is threaded, such that the anchor 2 can be screwed up and down on the rod 2 upon rotation (threads are not visible in the figures). The rod 4 may be connected to the anchor 2 in the middle of the anchor 2, such that the anchor 2 extends lengthwise outwards from the rod 2. The anchor 2 preferably extends symmetrical outwards from the rod 2. In order to prevent the anchor 2 from disconnection from the rod 4, the rod 4 may comprise a stopper 5 at a lower end. As the anchor 2 is screwed down to its extreme position on the rod 4, the stopper 5 thus prevents the anchor 2 from disconnection from the rod 4.

The fastening device 1 further comprises a rotation element 6. The rotation element 6 is configured for positioning on a topside of the boards, and is configured for being rotated by a user. The rotation element 6 is connected to the rod 4. In the illustrated embodiment, the rod 4 extends through the rotation element 6 and comprises a nut 7 fixed to an upper end of the rod 4. The nut 7 and rod 4 may rest in a corresponding opening 8 in the rotation element 6, in which rotation of the nut 7 and rod 4 relative to the rotation element 6 is thus prevented. As the rotation element 6 is rotated by a user, the rod 4 is thus also rotated. Alternatively, the rod 4 may be fixed to the rotation element 6 such that these two elements are formed by one part.

When the rotation element 6 is rotated by a user, and the anchor 2 abuts an underside of a board and is thus prevented from rotating, the anchor 2 is consequently screwed upwards until sufficient pressure from the rotation element 6 on the topside and anchor 2 from the underside is applied to the board. A user of the fastening device 1 may notice a sudden increase in resistance when turning the rotation element 6 as the friction elements 3 has pierced the boards and the body of the anchor 2 abuts the boards. The fastening device 1 has then been adequately fastened.

The fastening device 1 may comprise fastening means, and preferably the rotation element 6 comprises connection means 9,10. In the illustrated embodiment, the connection means 9,10 is an opening 9 through which ropes, carbine hooks, etc. may be attached. The opening 9 is in the illustrated embodiment formed below a bridge 10 spanning the rotation element 6. The connection means 9,10 may act as a grip for a user when rotating the rotation element 6. Two fingers may easily pinch e.g. the bridge 10.

The rotation element 6 may further comprise openings 11 for draining water. Instead of water from accumulating on top of the rotation element 6, it can be drained through the openings 11, preventing e.g. water from freezing and corrupting the function of the fastening device 1. The openings 11 may also be used for visual inspection by the user, in order to visually check how the anchor 2 is oriented when it is positioned below two boards.

The fastening device 1 may further comprise a base 12. A portion of the base 12 is provided between the anchor 2 and the rotation element 6, i.e. the rod 4 extends through the base 12. The base 12 thus prevents the rotation element 6 from being in direct contact with the boards, and thus provides a smooth surface for the rotation element 6 to rotate against. Alternatively, the base 12 may also comprise connection means to which ropes, carbine hooks, etc. may be attached. The connection means on a base may simply be an opening or a bore through a part of the base, a protruding hook, etc.

The base 12 may extend upwards, and thus form a recess 15 for the rotation element 6 to be accommodated in. The base 12 may also extend outwards from the rotation element 6 and thus comprise a sloping side surface 13. The side surface 13 may provide the fastening device 1 with a smooth outer shape. The bridge 10 of the rotation element 6 may also be shaped with a shape corresponding to the side surface 13, such that ropes, clothing, etc. are prevented from accidentally being snagged in the fastening device 1 when fastened to e.g. the floor of a terrace.

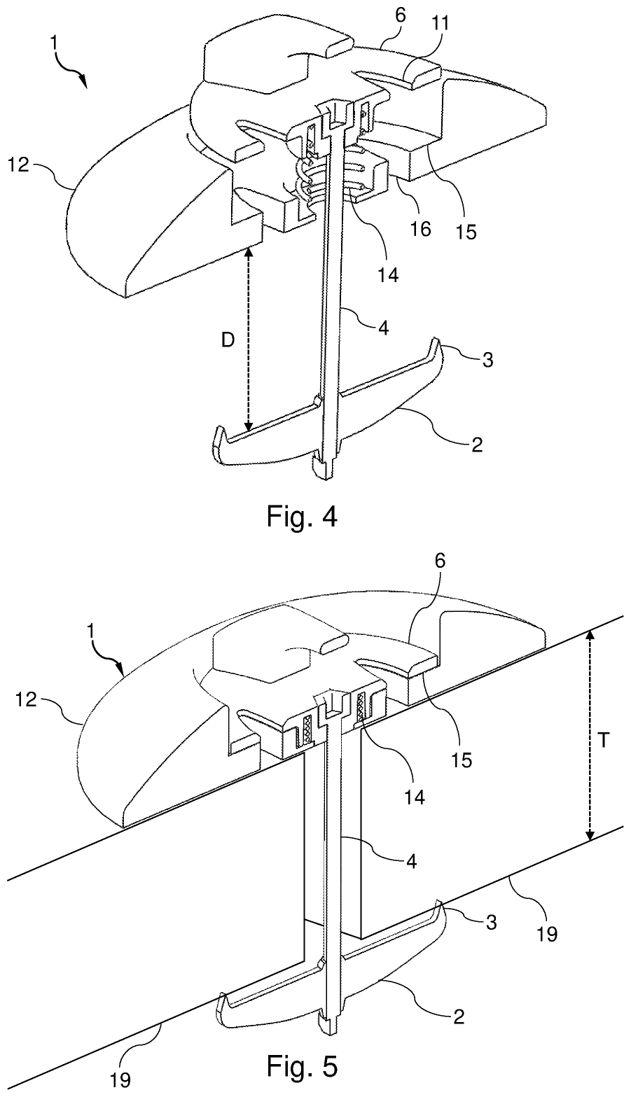

The fastening device may further comprise a spring 14. The spring 14 is provided on the underside of the rotation element 6, between the rotation element 6 and the base 12. The spring 14 is preferably a helical spring, and the rod 4 extends through the spring 14. The spring 14 may be compressed between the rotation element 6 and the base 12, and may bias the rotation element 6, and thus also the rod 4 and anchor 2, upwards. The spring 14 is further described with reference to FIGS. 4 and 5.

Referring now to FIG. 2, the base 12 may additionally comprise openings 16 for draining water and visual inspection. The openings 16 are shaped and positioned correspondingly to the openings 11 of the rotation element 6. When the rotation element 6 and base 12 are aligned, the openings 11,16 overlap and water can be drained from top of the rotation element 6, through the openings 11,16 and through the gap between the boards. Drainage is especially important if the base 12 is formed such that it forms a recess for the rotation element 6 to be positioned into.

The base 12 may also comprise cut-outs 17. The cut-outs 17 may be provided on the underside of the base 12, and especially below the side surface 13 if the side surface 13 extends far out. Cut-outs 17 save weight and reduce material usage.

In FIG. 2, an opening 18 in the bottom of the recess 15, is also visible. The rod 4 extends through the opening 18.

FIG. 3 illustrates the fastening device 1 when the anchor 2 has been inserted between and below two adjacent boards 19. The fastening device 1 has been guided in a downwards manner from a position above the boards 19 to the position in FIG. 3. When inserting the fastening device 1 between adjacent boards 19, the anchor 2 must be oriented such that the lengthwise direction of the elongate anchor 2 generally corresponds to the lengthwise direction of the gap between the two boards 19. In FIG. 3, this lengthwise direction corresponds to the direction in and out of the plane of the figure. The width W of the anchor 2, rod 4 or stopper 5 must thus not exceed the distance between the two boards 19. Most boards 19 are commonly spaced by about 2-10 mm, such that the greatest width W of the anchor 2, rod 4 or stopper 5 should be about 1-10 mm, more preferably about 2-5 mm and more preferably about 4 mm.

In FIG. 3, the rotation element 6 is in a lower position where it is inside the recess 15. The side surface 13 and bridge 10 may have a curved outer shape, and as the two elements together form a smooth and continuous surface, the fastening device 1 avoids snagging with other objects, as described previously. In this position, the rotation element 6 and opening 9 is also partly hidden by the base 12, and unwanted objects are prevented from accidentally bumping into the rotation element 6.

Referring now to FIGS. 4 and 5, FIG. 4 illustrates the fastening device 1 in a non-biased state, and FIG. 5 illustrates the fastening device 1 fastened to two boards 19. In FIG. 5, the rotation element 6 is positioned on the topside of the boards 19, and the anchor 2 is abutting the underside of the boards 19. In FIG. 4, the spring 14 is fully or near fully extended and the anchor 2 is screwed to the very end of the rod 4. Before installation of the fastening device 1, the anchor 2 may be screwed up or down on the rod 4 in order to adjust the distance D from the anchor 2 to the underside of the base 12. The distance D could be maximized by pressing the rotation element 6 all the way down into the recess 15, such that the spring 14 is fully compressed.

The distance D when the rotation element 6 is positioned against the recess 15 must not be less than the thickness T of the boards 19 the fastening device 1 is to be fastened to, but should preferably be a little bit more. If the thickness T of the boards 19 is not known, the distance D could be maximised, resulting in the user having to rotate the rotation element 6 a few rounds more than if the distance D was approximately equal to the thickness of the boards 19. The length of the rod 4 may be such that the distance D could in one embodiment be adjusted to accommodate boards 19 of thicknesses of e.g. 20-29 mm for private use, and in another embodiment accommodate boards 19 of thicknesses of e.g. 40-49 mm for professional use. The fastening device 1 could therefore easily be adapted to fastening to boards 19 of different thicknesses T.

When the anchor 2 has been positioned on the rod 4 such that the distance D is somewhat more than the thickness T of the boards 19, the anchor 2 and rod 4 is inserted in the gap between two adjacent boards 19 as described with reference to FIG. 3. The rotation element 6 may preferably have to be forced downwards somewhat such that the spring 14 is compressed (also as illustrated in FIG. 3), in order to be able to rotate the anchor 2 when the anchor 2 is positioned below the boards 19. When inserted through the gap between the boards 19, the anchor 2 may be more or less aligned with the gap, as illustrated and described with reference to FIG. 3. In order to make the anchor 2 abut the underside of the boards 19, the anchor 2 must be rotated somewhat. The most optimal rotation is 90° , such that the longitudinal direction of the anchor 2 is perpendicular to the gap between the boards 19, but any angle between about 10°-170° might suffice, depending on the width of the gap between the boards 19.

By visually inspecting the anchor 2 through the openings 11,16, it is easy to confirm the amount the anchor 2 has rotated, and if it has rotated at all. When the anchor 2 has rotated approximately 90°, as illustrated in FIG. 5, the friction elements 3 are positioned below the boards 19. The anchor 2 will thus abut the underside of the boards 19 when the rotation element 6 is released and the spring 14 biases the rotation element 6, rod 4 and anchor 2 upwards. When the anchor 2 abuts the boards 19, the biasing force from the spring 14 and the friction elements 3 prevent the anchor 2 from rotating further on the underside of the boards 19, even if the rotation element 6 is rotated.

The biasing force of the spring 14 alone may not be enough to securely fasten the fastening device 1 to the boards 19, such that the user may thereafter rotate the rotation element 6 and as such screw the anchor 2 and rotation element 6 towards each other. The rod 4 is thus screwed through the anchor 2, and the rotation element 6 is screwed into the recess 15 until the spring 14 is fully compressed and the anchor 2 is abutting the boards 19. Upon doing so, the friction elements 3 may penetrate the boards 19 and provide a secure anchoring of the anchor 2. The fastening device 1 is thus fastened to the boards 19. A similar, reverse action will release the fastening device 1 from the boards 19 without leaving any visible marks.

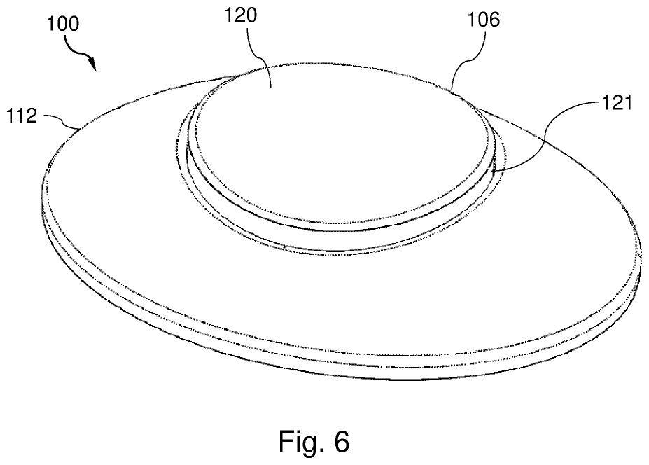

Referring now to FIG. 6, a second embodiment of a releasable fastening device 100 is shown. The releasable fastening device 100 is constructed and fastened to boards similarly to the first embodiment, but in the second embodiment, a solar panel 120 is provided on the rotation element 106. The solar panel 120 powers a light source 121. Alternatively, the solar panel 120 may charge a battery, provided to power the light source 121, as is known in the art of solar powered light sources. Alternatively, the solar panel and/or the light source may be provided on the base 112.

The light source 121 may be a LED strip arranged around the periphery of the rotation element 106. The releasable fastening device 100 may as such be used as a light source for decorating or lighting up a terrace or anywhere the releasable fastening device 100 could be fastened. The solar panel 120 may have a slight curvature, or be provided beneath a curved cover, so as to make an appealing aesthetic shape, avoid snagging, and minimize risk of striking the releasable fastening device 100 with a foot, etc.

The rotation element 106 is rotated similarly to the first embodiment, by gripping the rotation element 106 with the fingers and rotating it.

While the invention has been described with reference to the embodiments mentioned above, it is to be understood that modifications and variations can be made without departing from the scope of the present invention, and such modifications and variations shall remain within the field and scope of the invention.

1. A releasable fastening device for terraces and similar raised floors or structures provided by arranging boards side by side, comprising:
an anchor configured for insertion between two adjacent boards and abutment with an underside of the boards;
a rod in threaded connection with the anchor;
a rotation element connected to the rod, the rotation element configured for positioning on a topside of the boards and configured for being rotated by a user, the rotation element configured for rotating the rod to thereby screw the anchor towards the rotation element;
a base positioned between the anchor and the rotation element, thus preventing direct contact between the rotation element and the boards; and
a spring positioned between the base and the rotation element, the spring configured for compression as the anchor is positioned on the underside of the boards and biasing the anchor towards the underside of the boards.

2. (canceled)

3. The releasable fastening device according to claim 1, where the base further comprises a recess for accommodating the rotation element.

4. The releasable fastening device according to claim 1, where the base comprises openings for visual inspection and water drainage.

5. (canceled)

6. The releasable fastening device according to claim 1, where the spring is helical and the rod extends through the spring.

7. The releasable fastening device according to claim 1, where the anchor comprises at least one friction element for increasing the friction with the underside of the boards.

8. The releasable fastening device according to claim 7, where the at least one friction element is a point.

9. The releasable fastening device according to claim 7, where the anchor comprises two friction elements.

10. The releasable fastening device according to claim 1, where the anchor is elongate.

11. The releasable fastening device according to claim 1, where the anchor is symmetrical about a longitudinal axis.

12. The releasable fastening device according to claim 1, where the rotation element comprises connection means for connecting external devices to the fastening device.

13. The releasable fastening device according to claim 1, where the connection means is an opening through the rotation element.

14. The releasable fastening device according to claim 1, where the rotation element comprises openings for visual inspection and water drainage.

15. The releasable fastening device according to claim 1, where the rod comprises a stopper for preventing the anchor from being disconnected from the rod.

16. The releasable fastening device according to claim 1, where the rod is fixed to the rotation element.

17. The releasable fastening device according to claim 1, where the rod comprises a fixed nut for interlocking with a corresponding opening in the rotation element and is thus configured for preventing rotation of the nut and rod relative to the rotation element.
